(19) United States
(12) Patent Application Publication
(10) Pub. No.: US 2010/0208470 A1
(43) Pub. Date: Aug. 19, 2010

(54) OVERLAPPING ILLUMINATION SURFACES WITH REDUCED LINEAR ARTIFACTS

(76) Inventors: Yosi Shani, Maccabim (IL); Micha Zimmermann, Haifa (IL); Yigal Malyanker, Lod (IL); Danny Avner, Shemer (IL)

Correspondence Address: GOODWIN PROCTER LLP;PATENT ADMINISTRATOR, 53 STATE STREET, EXCHANGE PLACE, BOSTON, MA, 02109-2881, US

(21) Appl. No.: 12/703,422

(22) Filed: Feb. 10, 2010

Related U.S. Application Data
(60) Provisional application No. 61/151,347, filed on Feb. 10, 2009.
(60) Provisional application No. 61/151,351, filed on Feb. 10, 2009.

(51) Int. Cl. F21V 7/00; F21S 8/00

(52) U.S. Cl. 362/341; 362/317

(57) ABSTRACT

Illumination surfaces according to the present invention eliminate or at least reduce linear “stitch” artifacts at edges between tiled illumination devices. As a result, light of substantially uniform intensity is emitted across the entire illumination system. This is achieved, in various embodiments, overlapping the illumination surfaces of adjacent light-guide elements.

### RELATED APPLICATION

This application claims priority to and the benefit of U.S. Provisional Patent Application Nos. 61/151,347 and 61/151,351, filed on Feb. 10, 2009, the entire disclosures of which are incorporated by reference herein.

### FIELD OF INVENTION

This invention relates to illumination systems, and in particular to systems involving adjacent light-guide elements.

### BACKGROUND

Slim illumination systems are desirable for many illumination applications, and particularly for low-profile back-illuminated displays. A slim illumination system can be assembled by arranging many small lighting elements in an array. Each lighting element may be, for example, a light-guide panel having a light source that injects light into an “in-coupling” region of the panel. Light propagates from the in-coupling region to an “out-coupling” region of the panel, where it is emitted through an illumination surface to provide illumination. In general, the light is emitted substantially uniformly across the illumination surface.

In an array configuration, light-guide elements can be arranged such that only the illumination surfaces of the light-guide elements (except those at one border of the array) are visible from a location above the array. In this configuration, the in-coupling region of a light-guide element is positioned below the out-coupling region of an adjacent light-guide element. Thus, a viewer sees only the illumination surfaces of the light-guide elements in the array (except, once again, those at one border of the array).

The resulting discontinuity between adjacent light-guide elements may result in “stitches”—i.e., visible discontinuities in light intensity—in the array. These artifacts are visible in both the longitudinal and lateral directions.

One approach to minimizing stitch artifacts is to overlap the out-coupling regions of adjacent light-guide elements in an array. As a result, gaps between the illumination surfaces of adjacent light-guide elements are substantially eliminated. As the light-guide elements contract or expand due to a change in temperature, the borders of the out-coupling region of a light-guide element overlapping another light-guide element may shift to different locations, potentially creating stitch artifacts.

Indeed, stitch artifacts can be seen in an array of light-guide elements having overlapping out-coupling regions even without temperature changes. This can occur, for example, due to the extra light transmitted from the underlying illumination surface through the overlying light-guide element in the overlap region. Further contributing to visible stitch artifacts are internally reflecting end walls, which do not emit light and therefore appear dark, with the degree of visibility depending on the thickness of the end walls and the angle of view with respect thereto.

### SUMMARY OF THE INVENTION

Illumination devices according to the present invention can eliminate or at least reduce the “stitch” effect. As a result, light of substantially uniform intensity is emitted across the entire slim illumination system. Stitch artifacts arising from the spacing between overlapping illumination surfaces can be substantially eliminated or reduced by decreasing the thickness of the out-coupling region of a light-guide element overlapping another light-guide element, in the region of overlap. Stitch artifacts can also be substantially eliminated or at least mitigated by configuring the walls of the out-coupling regions of light-guide elements such that they emit some light, and thus compensate (at least partially) for the light discontinuity between overlapping out-coupling regions. Additionally, the walls of the out-coupling regions of light-guide elements may have mirrors that reflect the light emitted from the illumination surface of a light-guide element positioned below the wall. The reflected light may also compensate at least partially for the discontinuity, and may thus eliminate or at least mitigate stitch artifacts.

In one aspect, embodiments of the invention relate to an illumination device that includes first and second light-guide elements. The first light-guide element comprises a first in-coupling region, where a light source injects light into the light-guide element, and a first out-coupling region that emits the light through an illumination surface. The second light-guide element comprises a second in-coupling region and a second out-coupling region. The two light-guide elements are configured such that a portion of the first light-guide element overlaps a portion of the second light-guide element. In particular, at least a portion of the first out-coupling region overlaps the second in-coupling region but overlaps only a portion of the second out-coupling region. The light-guide elements are in slidable contact to permit relative movement with, for example, changes in temperature. In this arrangement, the second in-coupling region and a small portion of the second out-coupling region are hidden under the overlying first out-coupling region. Therefore, to a viewer positioned above the light-guide elements, only the illumination surfaces of the two out-coupling regions may be visible. To avoid artifacts arising from the addition of light through the first light-guide element from the underlying out-coupling region of the second light-guide element, an absorber may be provided between the elements in the region of overlap.

In some embodiments of the illumination device, the out-coupling regions each have a flat, planar bottom surface and an opposed illumination surface. Thus, the illumination surface and the bottom surface may be substantially parallel to each other. In some embodiments, however, the illumination surfaces of the out-coupling regions can have a thickness that diminishes along at least a portion of the light-guide element. Thus, the thickness of the first light-guide element may be at a maximum at the end near the in-coupling region, and at a minimum at the other end where the first out-coupling region overlaps the second out-coupling region. For example, the out-coupling regions may be smoothly angled relative to the bottom surfaces of the out-coupling regions

The first out-coupling region of the illumination device, in some embodiments, may have a partly reflective end wall opposite and facing the first in-coupling region. Some amount of the light propagated from the in-coupling region to the out-coupling region may be reflected back into the out-coupling region by the partly reflective wall, while some amount of light may be emitted from the partly reflective wall. The partly reflective end wall may be homogeneous or may comprise a pattern of reflective coating, with denser areas of the pattern reflecting more light.

In some embodiments of the illumination device, the first out-coupling region can have an externally reflective end wall opposite the first in-coupling region. Some amount of the light emitted from the illumination surface of the second out-coupling region, positioned below the first out-coupling region, may be incident upon the externally reflective wall, and subsequently, may be reflected by that wall.

### LIST OF FIGURES

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 is a plan view of light-guide elements arranged in an array to form an illumination area.

FIGS. 2A and 2B are plan and elevational views, respectively, of a single illumination element.

FIGS. 3A and 3B are sectional elevations of an illumination device.

FIG. 4 is a sectional elevation of an illumination device in which the distal end of the out-coupling region is thinner than the light-guide thickness at the in-coupling region.

FIG. 5 is a sectional elevation of an illumination device that has an end wall having an partially reflective internal surface.

FIG. 6 is a sectional elevation of an illumination device that has an end wall having an externally reflective surface.

FIGS. 7A and 7B is a sectional elevations of two illumination devices, respectively, in each of which the light-guide elements are spaced apart. The illumination device of FIG. 7B has an absorber positioned in between the two light-guide elements.

### DESCRIPTION

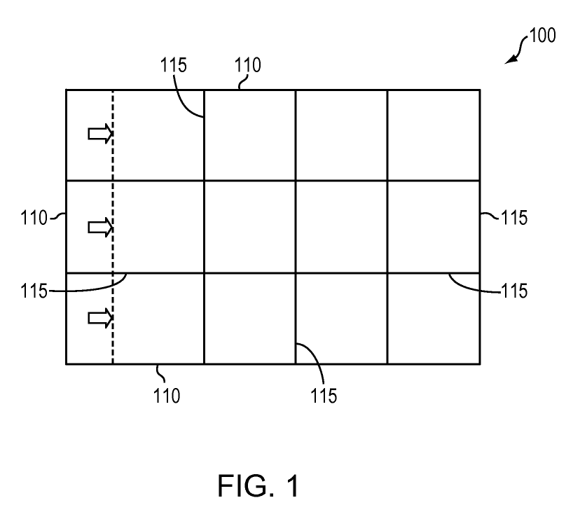

With reference to FIG. 1, an illumination surface 100 is formed by arranging a plurality of non-overlapping, adjacent light-guide elements 110 in an array. In the surface 100, gaps 115 occur between adjacent light guide elements 110. With changes in temperature, light-guide elements 110 can contract or expand, thereby changing the widths of the gaps 115 (which may be intentionally created to accommodate temperature-induced changes in the sizes of the light-guide elements 110). The dimensional response of the light-guide elements 110 to temperature depends on the material and dimensions of the light-guide element, as well as the mechanical harness used to create the array 100. For polymer-based light-guide elements the change in one dimension can be 0.1 mm per 25° C.

Positioning the light-guide elements so they overlap in one or both directions eliminates the need to reserve a gap for thermal expansion in that direction, because one light-guide element can slide over the other as it expands. It is desirable to position the light-guide elements so that each overlaps not only the out-coupling region of the neighboring light-guide element but also a portion of the neighboring light-guide element's out-coupling region. This ensures that over an expected range of expansion, the unilluminated surface of the in-coupling region will not be exposed.

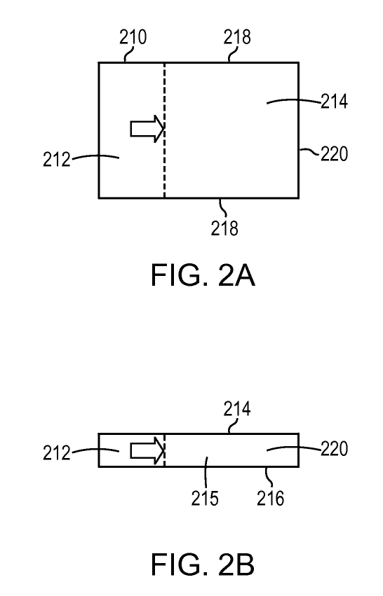

As shown in FIGS. 2A and 2B, an individual light-guide element 210 includes an in-coupling region 212, which receives light from a source such as a light-emitting diode (LED) (not shown); an out-coupling region 215 having illumination surface 214; and opposite to the illumination surface 214, a bottom surface 216. The light-guide element 210 also has side walls 218 and an end wall 220 distal to the in-coupling region 212. Light is generally emitted from the illumination surface 214.

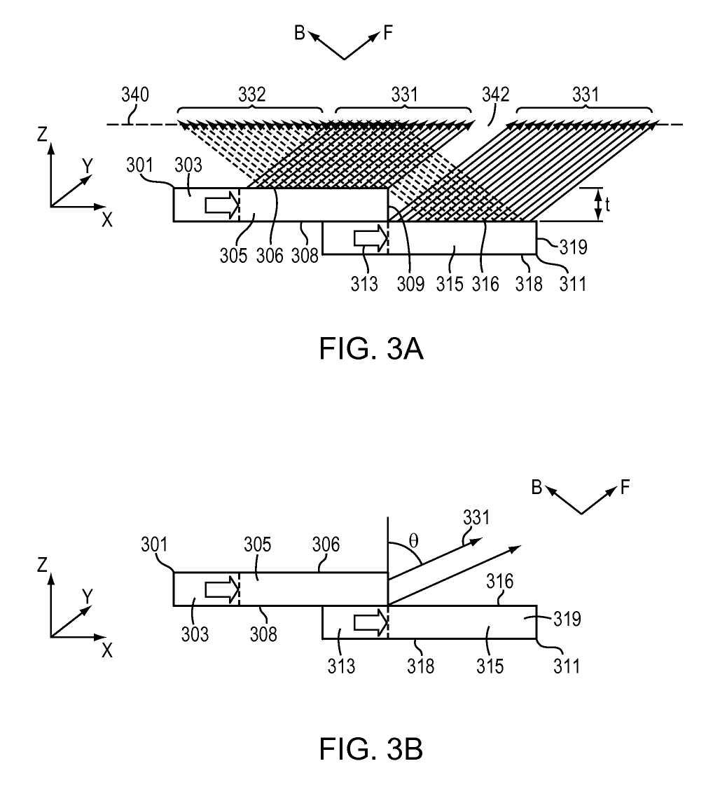

The problem of stitch artifacts arising from overlapping light-guide elements is illustrated in FIGS. 3A and 3B. A light-guide element 301 has an in-coupling region 303 and an out-coupling region 305. The out-coupling region 305 has an illumination surface 306 and an opposed bottom surface 308. The illumination surface 306 has out-coupling features (not shown) which can influence the angle with respect to Z axis at which rays are emitted from the illumination surface 306. In FIG. 3B, the angle between Z axis and ray 331 is denoted as θ. The out-coupling region 305 has an end wall 309 opposed to the in-coupling region 303. In FIG. 3A, the height of end wall 309 (i.e. the thickness of light-guide element 301) is denoted as t. Similarly, a light-guide element 311 has an in-coupling region 313 and an out-coupling region 315. The out-coupling region 315 has an illumination surface 316 and an opposed bottom surface 318. Out-coupling region 315 has out-coupling features (not shown), which may be, for example, along the bottom surface of region 315 or dispersed (as in the case of scattering particles) through the thickness thereof. The out-coupling region 315 has an end wall 319 opposed to the in-coupling region 313.

As shown in FIG. 3A, the in-coupling region 313 of light-guide element 311 is positioned under the out-coupling region 305 of light-guide element 301. A portion of the out-coupling region 315 of light-guide element 311 is positioned under light-guide element 301. The in-coupling region 313 of light-guide element 311 is in contact with the bottom surface 308 of the out-coupling region 305 of light-guide element 301. Thus, there may be substantially no vertical gap (i.e., along the Z axis) between the out-coupling region 305 of light-guide element 301 and the in-coupling region 313 of light-guide element 311. It should be understood that this configuration is illustrative only, and that a configuration of overlapping out-coupling regions having a spacing between such out-coupling regions (e.g., due to mechanical assembly requirements or limitations, or to permit introduction of an absorber as described below) is within the scope of this invention.

When temperature changes, light-guide elements 301 and 311 may expand or contract along their lengths (i.e., along the X axis) or along their widths (i.e., along Y axis). Light-guide elements 301 and 311 do not expand or contract substantially, however, along their height dimensions (i.e., along the Z axis). Therefore, even when the temperature changes, the out-coupling region 305 of light-guide element 301 remains in contact with the in-coupling region 313 of light-guide element 311. This characteristic of light-guide elements can be useful in eliminating or substantially reducing stitch artifacts resulting from a change in temperature, as described below.

The rays denoted 331 are emitted from the illumination surfaces 306, 316 of light-guide elements 301, 311, respectively, in a forward direction, denoted F. Additionally, the rays denoted 332 are emitted from the illumination surfaces 306, 316 in a backward direction, denoted B. Rays may not be emitted through the end wall 309 of light-guide element 301, however. Because end wall 309 emits no light, a dark stitch artifact 342 occurs. A stitch occurs even if the end face is unreflective, however, because in that case, too much light will be emitted through the end face. As a result, the stitch will be bright instead of dark.

The width of the stitch artifact is given by the expression W_{stitch}=t tan (θ), where t is the thickness of end wall 309 and θ is the angle between rays 331 and the Z axis. It should be understood that θ represents the smallest angle between rays 331 and Z axis that can reach the illuminated plane 340. This is because rays from illumination surface 306 emitted at angles greater than θ are not visible and therefore do not affect the stitch artifact. The rays actually observed depend on the relative position of the observer and on the illumination system geometry. In some applications there are additional optical means that may limit or filter the rays that can reach the illuminated plane 340 as done by brightness enhancement foils in backlight unit for LCD.

According to the expression above, the width of stitch 342 increases as the thickness of end wall 309 increases. Stitch 342 also appears wider if angle θ is large, i.e. if rays 331 are emitted at an angle close to the X axis. As explained above, if the temperature changes, the length and width of a light-guide element may change, but there may no substantial change in a light-guide element's thickness. Similarly, the angles at which rays are emitted through the out-coupling features in an illumination surface also generally does not change with temperature. Therefore, the width of a stitch arising due to the configuration shown in FIG. 3A may not change substantially in response to temperature changes.

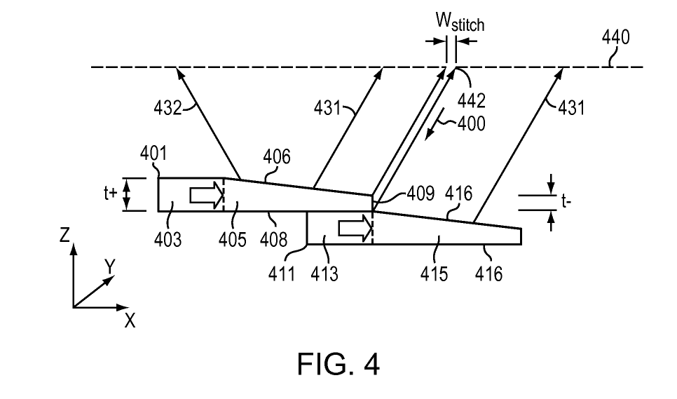

We now describe various embodiments of an illumination device that address stitch artifacts caused by the end wall of an overlapping a light-guide element. With reference to FIG. 4, an illumination device 400 includes a first light-guide element 401, which itself has an illumination surface 406. The thickness of light-guide element 401 diminishes to t− at the end wall 409, which is less than the thickness t+ at the in-coupling region 403. For example t− can be 0.5 mm and t+ equal to 1 mm. As a result, the surface 406 may not be parallel to the bottom surface 408 of light-guide element 401, but instead follows an angle with respect thereto. According to the expression set forth above, the reduction in t to t− produces a narrower stitch 442 in the illuminated plane 440. This is also the case with respect to the second light-guide element 411, with which light-guide element 401 overlaps.

A commensurate reduction in the stitch effect can also be achieved by using a light-guide element having a uniformly small thickness t−. Such a light-guide element may be structurally weak, however, compared to light-guide element 401, 411 and it may not emit light of a desired intensity. In a typical light-guide element, the intensity of light emitted from the illumination surface is directly related to the number of rays reflected by the bottom surface toward the illumination surface. The latter number depends on the distance between the illumination and bottom surfaces. Thus, if the thickness of a light-guide element is uniformly small, its illumination and bottom surfaces may be too close to each to achieve the desired light output. Therefore, a light-guide element having uniformly small thickness may be unsuitable for applications that require high brightness.

Illumination device 400 exhibits adequate strength because the thinnest portion overlaps the adjacent element, and because the thickness of the element diminishes only gradually to t−, the bottom surfaces 408, 418 can reflect a substantial amount of light within the respective elements.

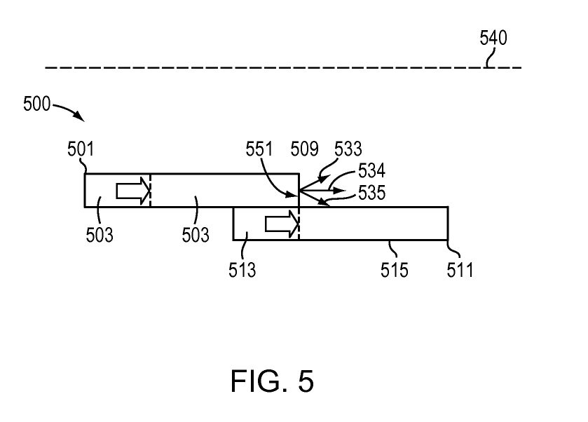

FIG. 5 shows another embodiment 500 of an illumination device according to the present invention. A first light-guide element 501 is positioned above a second light-guide element 511 such that the out-coupling region 505 of light-guide element 501 overlaps the in-coupling region 513 and a portion of the out-coupling region 515 of light-guide element 511. The out-coupling region 505 does not overlap a significant portion of the out-coupling region 515.

The inside surface of end wall 509 (i.e., the surface facing the in-coupling region 503) has a partially reflecting mirror 551. By “partly reflecting” is meant that the mirror 551 reflects at least 5% of the incident light, and preferably at least 30%, but no more than 95%. A partly reflecting mirror can be fabricated, for example, by applying a partly reflective coating on an end wall or by patterning a coated end wall with small openings through which some of the light is emitted.

Mirror 551 reflects a portion of light incident upon it to the out-coupling region 505, and allows a portion of light to be emitted from end wall 509 as rays 533, 534, 535. At least a portion of the light emitted from end wall 509 may reach the illuminated plane 540 as rays 533. The reflectivity of mirror 551 is selected such that the amount of light emitted from end wall 509 (in particular, the number of rays 533) is substantially the same as the amount of light that would reach plane 540 in the absence of an end wall 509. As a result, the stitch artifact that would occur due to the end wall 509 is substantially eliminated or at least reduced.

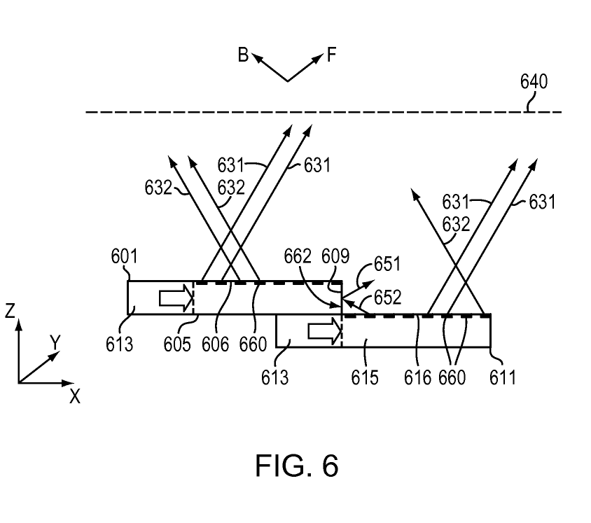

In another embodiment, illustrated in FIG. 6, the end wall 609 of light-guide element 601 has a mirror 662 on its outer surface (i.e., the surface facing the space above the illumination surface 616 of light-guide element 611). The out-coupling regions 605, 615 of light-guide elements 601, 611, respectively, have out-coupling features 660 such as printing dots (shown schematically). The out-coupling features 660 are selected such that the distribution of light emitted from illumination surfaces 606, 616 in backward and forward directions (denoted B and F, respectively) is symmetrical. A symmetrical light distribution in backward and forward direction means that the angle of rays 632 with respect to the Z axis and the angle of rays 631 with respect to the Z axis are substantially the same in magnitude but opposite in direction.

A backward ray 652 emitted from illumination surface 616 has substantially the same angle with respect to the Z axis as rays 632. Ray 652 is incident upon mirror 662 of end wall 609. Mirror 662 reflects ray 652 as ray 651. Because rays 631, 632 have a symmetrical distribution, the reflected ray 651 is emitted substantially at the same angle with respect to the Z axis as rays 631. Thus, the light that would not have reached an illuminated plane 640 had the end wall 609 been without mirror 662 is replaced by rays 651. As a result, the stitch artifact may be substantially eliminated or reduced. As described above, the distribution of light from out-coupling features 660 does not change with temperature, so the efficacy of stitch correction does not vary with temperature changes.

It should be noted that the embodiment shown in FIG. 5 is particularly useful in connection with configurations where most of the light is out-coupled in the forward direction. The embodiment shown in FIG. 6 is particularly useful in connection with configurations where the out-coupled light is distributed evenly between the forward and backward directions (e.g., a Lambertian distribution).

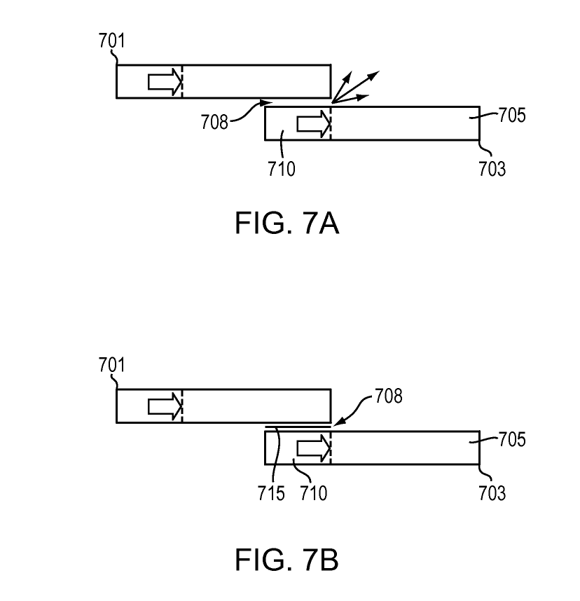

In some embodiments, light-guide elements can overlap one another, in part, without making contact. Such an illumination device is shown in FIGS. 7A and 7B. In the illustrated embodiments, a gap separates the overlapping portions of the light-guide elements 701, 703 and light from the portion of out-coupling region 705 (of light-guide element 703) that underlies the gap 708 is emitted therefrom. Light trapped in gap 708 can propagates to the right and escapes at the end of light-guide element 701. This light can create a bright stitch artifact due its different light distribution. As shown in FIG. 7B, the bottom of the upper light-guide element 701 may be coated with an absorber 715 for absorbing this stray light.

Although the present invention has been described with reference to specific details, it is not intended that such details should be regarded as limitations upon the scope of the invention, except as and to the extent that they are included in the accompanying claims.

What is claimed is:

1. An illumination device comprising:
a first light-guide element comprising a first in-coupling region and a first out-coupling region; and
a second light-guide element comprising a second in-coupling region and a second out-coupling region, a portion of the first light-guide element overlapping in slidable contact with a portion of the second light-guide element such that at least a portion of the first out-coupling region overlaps the second in-coupling region and only a portion of the second out-coupling region.

2. The illumination device of claim 1, wherein the out-coupling regions each have a flat, planar bottom surface and an opposed illumination surface.

3. The illumination device of claim 1, wherein the first light-guide element has a thickness that diminishes along at least a portion thereof to a minimum thickness at an end where the first out-coupling region overlaps the second out-coupling region.

4. The illumination device of claim 3, wherein the illumination surfaces of the out-coupling regions are angled relative to the bottom surfaces of the out-coupling regions.

5. The illumination device of claim 1, wherein the first light-guide element comprises a first in-coupling region and the second light-guide element comprises a second in-coupling region, at least the first out-coupling region having a partly reflective end wall opposite and facing the first in-coupling region.

6. The illumination device of claim 1, wherein:
the first light-guide element comprises a first in-coupling region and the second light-guide element comprises a second in-coupling region; and
at least the first out-coupling region has an externally reflective end wall opposite the first in-coupling region.

7. The illumination device of claim 6, wherein the externally reflective end wall is semi-transparent so as to be internally and externally reflective.

8. The illumination device of claim 7, wherein the first and second light-guide elements are vertically spaced apart and further comprising an absorber between the first and second light-guide elements where they overlap.

9. The illumination device of claim 5, wherein the partly reflective end wall comprises a pattern of reflective coating, the pattern comprising a plurality of openings.

10. The illumination device of claim 5 wherein the first light-guide element has a thickness that diminishes along at least a portion thereof to a minimum thickness at an end where the first out-coupling region overlaps the second out-coupling region.

11. The illumination device of claim 6 wherein the first light-guide element has a thickness that diminishes along at least a portion thereof to a minimum thickness at an end where the first out-coupling region overlaps the second out-coupling region.

12. The illumination device of claim 3 wherein the first and second light-guide elements are vertically spaced apart.
